(19) United States
(12) Patent Application Publication
(10) Pub. No.: US 2024/0208773 A1
(43) Pub. Date: Jun. 27, 2024

(54) METHOD AND AN ELEVATOR MONITORING UNIT FOR DEFINING LOAD DATA OF AN ELEVATOR CAR

(71) Applicant: KONE Corporation, Helsinki (FI)

(72) Inventor: Matti Mustonen, Helsinki (FI)

(73) Assignee: KONE Corporation, Helsinki (FI)

(21) Appl. No.: 18/595,757

(22) Filed: Mar. 5, 2024

Related U.S. Application Data
(63) Continuation of application No. PCT/EP2021/077502, filed on Oct. 6, 2021.

(51) Int. Cl. B66B 1/34; B66B 5/00

(52) U.S. Cl. CPC B66B 1/3476; B66B 5/0018

(57) ABSTRACT

The invention relates to a method for defining load data of an elevator car. The method comprises obtaining, by at least one motion sensor device, speed data representing a speed of an asynchronous elevator hoisting motor arranged to drive the elevator car along an elevator shaft; and defining the load data of the elevator car based on the obtained speed data, a direction of the elevator drive, and predefined reference data. The invention relates also to an elevator monitoring unit, a computer program product, and a system for defining load data of the elevator car.

### TECHNICAL FIELD

The invention concerns in general the technical field of elevator systems. Especially the invention concerns monitoring elevator systems.

### BACKGROUND

An elevator system comprises typically at least one elevator car and an elevator hoisting motor arranged to drive the elevator car along an elevator shaft between a plurality of landings. The elevator system may typically further comprise one or more internal sensor devices for providing various operation data of the elevator system. The operation data may comprise e.g. load data of the at least one elevator car. For example, the elevator system may comprise a load weighting device arranged to each elevator car for providing the load data of said elevator car. The load data may be used e.g. for people flow monitoring, detecting entrapment situations, etc. However, there may exist situations, where there is no access to the elevator control system of the elevator system and thus the load data of the at least one elevator car is not available, for example in case remote monitoring or maintenance of third-party elevator systems. Alternatively or in addition, there may exists situations, where an alternative way to define the load data of the at least one elevator car may be needed.

Therefore, there is a need to develop further solutions for defining load data of an elevator car.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator monitoring unit, a computer program product, and a system for defining load data of an elevator car. Another objective of the invention is that the method, the elevator monitoring unit, the computer program product, and the system for defining load data of an elevator car for enables defining the load data of the elevator car without a connection to an elevator control system of an elevator system comprising the elevator car.

The objectives of the invention are reached by a method, an elevator monitoring unit, a computer program product, and a system as defined by the respective independent claims.

According to a first aspect, a method for defining load data of an elevator car is provided, wherein the method comprises: obtaining, by at least one motion sensor device, speed data representing a speed of an asynchronous elevator hoisting motor arranged to drive the elevator car along an elevator shaft; and defining the load data of the elevator car based on the obtained speed data, a direction of the elevator drive, and predefined reference data.

The predefined reference data may comprise a scaling factor and slip data with a known load to the direction of the elevator drive.

The predefined reference data may further comprise a synchronous speed data.

When the direction of the elevator drive is upwards the load data of the elevator car may be defined according to the formula:

$${m}_{load} = ( {S}_{up\_load} - {S}_{up\_known} ) / {k}_{up} + {m}_{known} ,$$

where s_{up_known} is slip dataof with the known load upwards, kᵤₚ is a scaling factor upwards, s_{up_load} is slip data with the load data to be defined upwards, and m_{known} is a mass of the known load, wherein the slip data with the load data to be defined upwards may be comprised in the obtained speed data or defined based on the obtained speed data and synchronous speed data.

Alternatively, when the direction of the elevator drive is downwards the load data of the elevator car may be defined according to the formula:

$${m}_{load} = ( {S}_{down\_load} - {S}_{down\_known} ) / {k}_{down} + {m}_{known} ,$$

where s_{down_known} is slip data with the known load downwards, k_{down} is a scaling factor downwards, and s_{down} load is slip data with the load data to be defined downwards, wherein the slip data with the load data to be defined downwards may be comprised in the obtained speed data or defined based on the obtained speed data and the synchronous speed data.

The reference data may be defined during a learning drive of the elevator car.

The learning drive may comprise: obtaining first reference speed data representing the speed of the elevator hoisting motor, when the elevator car with a first known load is driven upwards and downwards along the elevator shaft; obtaining second reference speed data representing the speed of the elevator hoisting motor, when the elevator car with a second known load is driven upwards and downwards along the elevator shaft; and defining the reference data based on the obtained first reference speed data and the obtained second reference speed data.

The defining the reference data during the learning drive may comprise: defining synchronous speed data based on the obtained first reference speed data or the obtained second reference speed data, defining slip data with the first known load to both directions based on the defined synchronous speed data and the obtained first reference speed data, defining slip data with the second known load to both directions based on the defined synchronous speed data and the obtained second reference speed data, and defining the scaling factor based on the defined data r with the known loads upwards or downwards, and the known first and second loads.

Alternatively, the defining the reference data during the learning drive may comprise defining the scaling factor based on slip data with the known loads upwards or downwards, and the known first and second loads, wherein the slip data with the first known load upwards and downwards may be comprised in the obtained first reference speed data and the slip data with the second known load upwards and downwards may be comprised the second reference speed data.

The at least one motion sensor device may be comprised by an elevator monitoring unit without a communicative connection to a control system of an elevator system comprising the elevator car.

The asynchronous elevator hoisting motor may be a direct-on-line (DOL) induction motor or a frequency-controlled induction motor.

According to a second aspect, an elevator monitoring unit for defining load data of an elevator car is provided, wherein the monitoring unit comprises: at least one motion sensor device configured to obtain speed data representing a speed of an asynchronous elevator hoisting motor arranged to drive the elevator car along an elevator shaft, and a processing unit configured to: obtain the speed data from the at least one motion sensor device; and define the load data of the elevator car based on the obtained speed data, a direction of the elevator drive, and predefined reference data.

The predefined reference data may comprise a scaling factor and slip data with a known load to the direction of the elevator drive.

The predefined reference data may further comprise a synchronous speed data.

When the direction of the elevator drive is upwards, the processing unit may be configured to define the load data of the elevator car according to the formula:

$${m}_{load} = ( {S}_{up\_load} - {S}_{up\_known} ) / {k}_{up} + {m}_{known} ,$$

where s_{up_known} is slip data with a known load upwards, kᵤₚ is a scaling factor upwards, and s_{up_load} is slip data with the load data to be defined upwards, wherein the slip data with the load data to be defined upwards may be comprised in the obtained speed data or defined based on the obtained speed data and synchronous speed data.

Alternatively, when the direction of the elevator drive is downwards, the processing unit may be configured to define the load data of the elevator car according to the formula:

$${m}_{load} = ( {S}_{down\_load} - {S}_{down\_known} ) / {k}_{down} + {m}_{known} ,$$

where s_{down_known} is slip data with the known load downwards, k_{down} is a scaling factor downwards, and s_{down_load} is slip data with the load data to be defined downwards, wherein the slip data with the load data to be defined downwards may be comprised in the obtained speed data or defined based on the obtained speed data and the synchronous speed data.

The processing unit may be configured to define the reference data during a learning drive of the elevator car.

The learning drive may comprise that the processing unit is configured to: obtain first reference speed data representing the speed of the elevator hoisting motor, when the elevator car with a first known load is driven upwards and downwards along the elevator shaft; obtain second reference speed data representing the speed of the elevator hoisting motor, when the elevator car with a second known load is driven upwards and downwards along the elevator shaft; and define the reference data based on the obtained first reference speed data and the obtained second reference speed data.

The defining the reference data during the learning drive may comprise that the processing unit is configured to: define synchronous speed data based on the obtained first reference speed data or the obtained second reference speed data, define slip data with the first known load to both directions based on the defined synchronous speed data and the obtained first reference speed data, slip data with the second known load to both directions based on the defined synchronous speed data and the obtained second reference speed data, and define the scaling factor based on the defined slip data with the known loads upwards or downwards and the known first and second loads.

Alternatively, the defining the reference data during the learning drive may comprise that the processing unit is configured to define the scaling factor based on slip data with the known loads upwards or downwards and the known first and second loads, wherein the slip data with the first known load upwards and downwards may be comprised in the obtained first reference speed data and the slip data with the second known load upwards and downwards may be comprised the second reference speed data.

The elevator monitoring unit may be without a communicative connection to a control system of an elevator system comprising the elevator car.

The asynchronous elevator hoisting motor may be a direct-on-line (DOL) induction motor or a frequency-controlled induction motor.

According to a third aspect, a computer program product for defining load data of an elevator car is provided, which computer program product, when executed by a computer, cause the computer to perform the method as described above.

According to a fourth aspect, a system is provided, wherein the system comprises the elevator monitoring unit as described above and an external computing unit configured to: receive the load data of the elevator car from the elevator monitoring unit, and store and analyze the received load data of the elevator car.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of a method for defining load data of an elevator car.

FIG. 3 illustrates schematically an example of a learning drive for defining reference data.

FIG. 4 illustrates schematically another example of the learning drive for defining reference data.

FIG. 5 illustrates schematically an example of components of an elevator monitoring unit.

FIG. 6 illustrates schematically an example a system comprising an elevator monitoring unit and an external computing unit.

### DESCRIPTION OF THE EXEMPLIFYING EMBODIMENTS

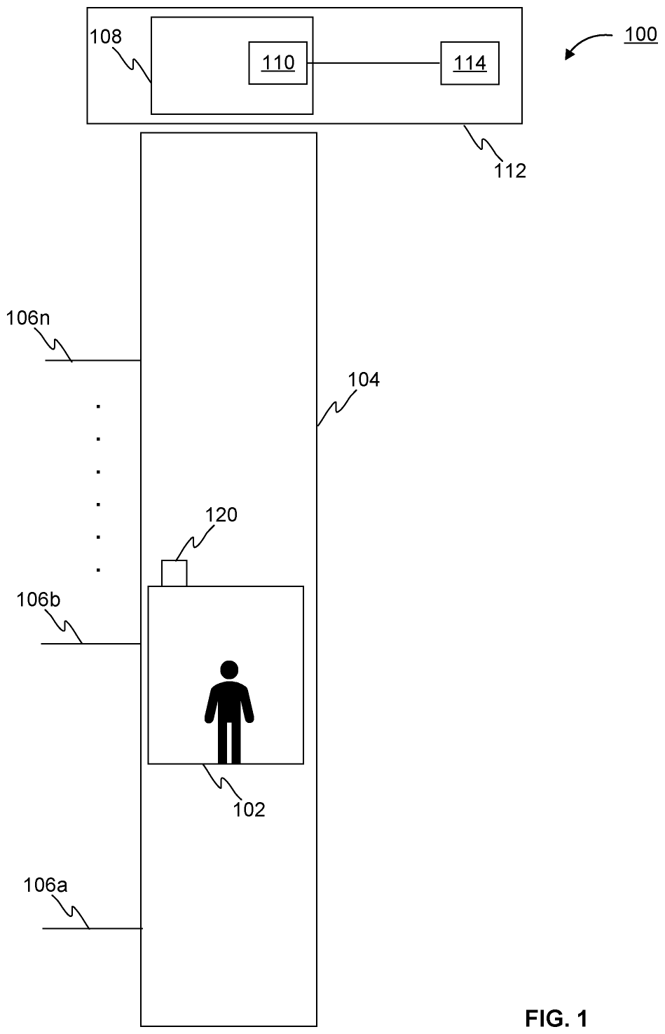

FIG. 1 illustrates schematically an example of an elevator environment, i.e. an elevator system 100, wherein an elevator monitoring unit 120 may be implemented as will be described. The elevator system 100 comprises an elevator car 102 configured to travel along an elevator shaft 104 between a plurality of landings, i.e. floors, 106a-106n. The elevator system 100 further comprises an elevator hoisting machinery 108 comprising an elevator hoisting motor 110 arranged to drive the elevator car 102 along the elevator shaft 104. The elevator hoisting machinery 108 may further comprise one or more known elevator hoisting machinery entities, such as one or more sheaves and/or pulleys, brakes, etc., which are not shown in FIG. 1 for sake of clarity. The elevator hoisting machinery 108 may be arranged inside a machine room 112 residing above the elevator shaft 104, or alternatively the elevator hoisting machinery 108 may be located inside the elevator shaft 104 (e.g. in a machine-room-less elevator system). The elevator hoisting motor 110 is an asynchronous motor. The asynchronous elevator hoisting motor 110 may be an induction motor, e.g. a direct-on-line (DOL) induction motor (e.g. a one-speed DOL induction motor or a two-speed DOL induction motor) or a frequency-controlled induction motor (e.g. an open-loop scalar controlled induction motor). The elevator system 100 further comprises an elevator control system 114 configured to control the operation of the elevator system 100 at least in part. The elevator control system 114 may reside e.g. in the machine room 112 as shown in FIG. 1 or in one of the landings 106a-106n of the elevator system 100. The elevator control system 114 may for example comprise an elevator drive unit configured to control the elevator hoisting motor 110 to drive, i.e. move, the elevator car 102 along the elevator shaft 104. In case of the DOL induction motor, the elevator control system 114 may comprise a controllable switch, e.g. a contactor or the like, between the elevator hoisting motor 110 and a 3-phase supply network. Alternatively, the induction motor may be controlled by a frequency controller, e.g. inverter, for example, if a variable speed is required. The elevator system 100 may further comprise one or more known elevator related entities, e.g. elevator suspension means, e.g. rope or belt, for carrying, i.e. suspending, the elevator car 102 and a counterweight, safety circuit and devices, an elevator door system, etc., which are not shown in FIG. 1 for sake of clarity.

The elevator monitoring unit 120 may be implemented as an external entity to the elevator system 100. This means that the elevator monitoring unit 120 is not connected, i.e. is without a communicative connection, to the elevator control system 114. In other words, the elevator monitoring unit 120 does not have access to the elevator control system 114, which causes that the elevator monitoring unit 120 does not have access to any data obtained or defined by the elevator control system 114. Therefore, if the elevator monitoring unit 120 is implemented as the external entity, the elevator monitoring unit 120 is not capable to obtain data representing a load of the elevator car 102 from the elevator control system 114. According to an example, the elevator monitoring unit 120 may be implemented in a third-party elevator system, in which the access to the elevator control system 114 is not available.

The elevator monitoring unit 120 comprises at least one motion sensor device 550 for obtaining speed data representing a speed of the elevator hoisting motor 110. The at least one motion sensor device 550 may comprise at least one internal sensor device of the elevator monitoring unit 120 and/or at least one external sensor device to the elevator monitoring unit 120 communicatively coupled to the elevator monitoring unit 120. The communication between the elevator monitoring unit 120 and the at least one external motion sensor device 550 may be based on one or more known communication technologies, either wired or wireless. The elevator monitoring unit 120 and at least one of the at least one motion sensor device 550 of the monitoring unit 120 may be arranged to the elevator car 102, e.g. to a rooftop of the elevator car 102, as illustrated in the example of FIG. 1. Alternatively, at least one of the at least one motion sensor device 550 of the monitoring unit 120 may be arranged to the elevator car 102 and the elevator monitoring unit 120 itself may be arranged to any other suitable location within the elevator system, e.g. to one of the landings 106a-106b of the elevator system 100 or to the machine room 112.

Preferably, the obtained speed data may comprise elevator car speed data representing a speed of the elevator car 102. The elevator car speed data corresponds to, i.e. correlates with, the speed, e.g. a rotational speed, of the elevator hoisting motor 110. The elevator car speed data may comprise for example speed of the elevator car 102, acceleration of the elevator car 102, position/location of the elevator car 102 inside the elevator shaft 104, and/or any other data representing the speed of the elevator car 102. Alternatively or in addition, the elevator car speed data may comprise for example any speed data associated with the movement mechanism of the elevator car 102 that correlates with the speed of the elevator hoisting motor 110. In case the obtained speed data comprises the elevator car speed data the at least one motion sensor device 550 may for example comprise an accelerometer, an air pressure sensor device configured to provide height data of the elevator car 102 inside the elevator shaft 104, a magnetometer configured to provide the speed data by using positioning based on a magnetic map of the elevator shaft 104, an imaging device (e.g. a camera or any other visual-based device), a magnetic tape reader device, a laser distance measurement device, a radar, a (ultra)sound-based distance measurement device, and/or a low pulse encoder device arranged e.g. to a pulley. Obtaining the elevator car speed data enables a simple way to obtain the speed data representing the speed of the elevator hoisting motor 110 without a need to directly measure the speed of the elevator hoisting motor 110 from the elevator hoisting motor 110. The rotational speed of the elevator hoisting motor 110 and/or a slip of the elevator hoisting motor 110 may be defined based on the elevator car speed data.

Alternatively, the obtained speed data may comprise rotational speed data representing the rotational speed of the elevator hoisting motor 110 or slip data representing a slip of the elevator hoisting motor 110. The term “slip data” means throughout this application the slip of the elevator hoisting motor 110 or a corresponding elevator component related speed difference value from the speed that corresponds to the speed of said elevator component, when the elevator hoisting motor 110 operates at a synchronous speed. The elevator component may be any elevator component of the elevator system 110 mechanically linked to the elevator hoisting motor 110 and moved by the elevator hoisting motor 110, e.g. the elevator car 102, a sheave, a pulley, or any other elevator component moved by the elevator hoisting motor 110. In case the obtained speed data comprises the rotational speed data the at least one motion sensor device 550 may be a proximity sensor device arranged to a rotor shaft of the elevator hoisting motor 110. The proximity sensor device may be for example an inductive based proximity sensor device or a visual based proximity sensor device, e.g. a tachometer. The proximity sensor device comprises at least one indicator (e.g. a magnet or a mark having a specific color, e.g. white) device attached to the circumference of the rotator shaft and a stationary sensor configured to detect the proximity of the at least one indicator device. One indicator is enough to obtain the rotational of the elevator hoisting motor 110, but two or more indicators are needed to obtain also the direction of the rotation. In case the obtained speed data comprises the slip data the at least one motion sensor device 550 comprises a sensor device configured to provide the slip data.

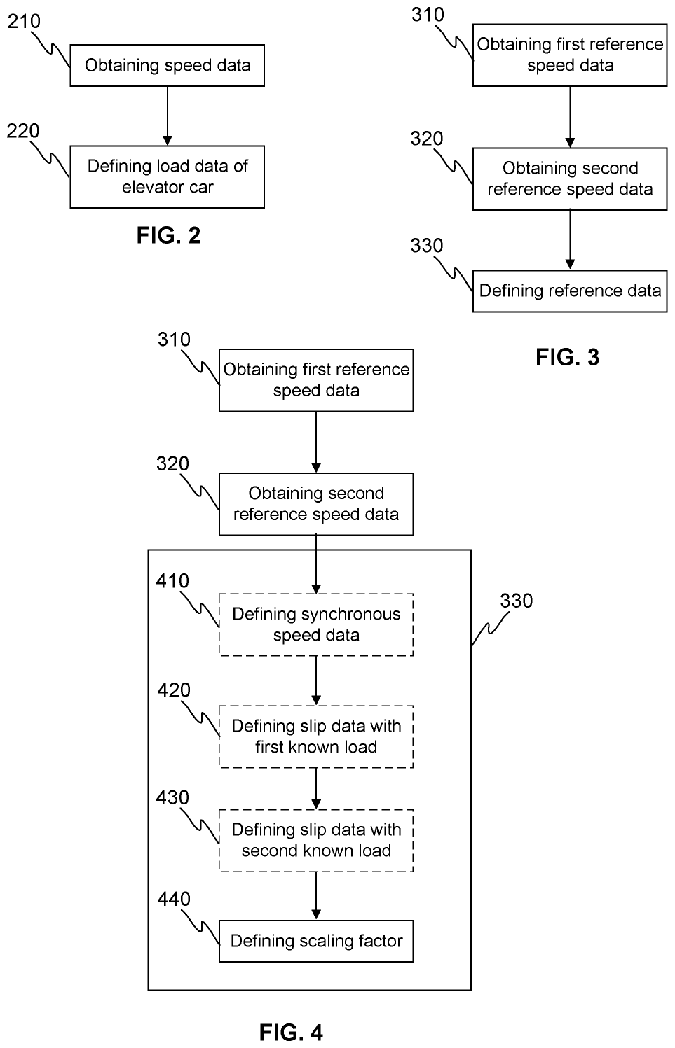

An example of a method for defining load data of an elevator car 102 is described by referring to FIG. 2, which illustrates the method as a flow chart. At a step 210, the elevator monitoring unit 120 obtains, by the at least one motion sensor device 550, the speed data. The obtained speed data represents the speed of the elevator hoisting motor 110. The obtained speed data may comprise the elevator car speed data, the rotational speed data or the slip data as discussed above. The speed data may for example be expressed in revolutions per minute (RPM) or in meters per second (m/s). An elevator drive comprises different phases, e.g. an acceleration phase, a steady state speed phase, and a deceleration phase. The speed data may be obtained during the steady state speed phase of the elevator drive. Alternatively or in addition, the speed data may be obtained at least partly during the last part of the acceleration phase of the elevator drive and/or at least partly during the beginning part of the deceleration phase of the elevator drive. Alternatively, the at least one motion sensor device 550 may obtain the speed data continuously during the elevator drive, and a processing unit 510 of the elevator monitoring unit 120 may select from among the continuously obtained speed data the speed data obtained during the steady state speed phase, the speed data obtained at least partly during the last part of the acceleration phase of the elevator drive, and/or the speed data obtained at least partly during the beginning part of the deceleration phase of the elevator drive. Before beginning of the elevator drive, the elevator hoisting motor 110 is in a stationary phase. During the acceleration phase of the elevator drive the speed of the elevator hoisting motor 110 increases from the stationary to the steady state speed. The steady state speed phase of the elevator drive begins when the steady state speed of the elevator hoisting motor 110 is reached.

During the steady state speed phase of the elevator drive the elevator hoisting motor 110 drives the elevator car 102 at the steady state speed. The steady state speed may be defined by a supply frequency and the load of the elevator car 102. The deceleration phase of the elevator drive, in turn, begins when the speed of the elevator hoisting motor 110 starts to decrease from the steady state speed. During the deceleration phase of the elevator drive the speed of the elevator hoisting motor 110 decreases from the steady state speed to stationary. One or more of the phases of the elevator drive may further comprise one or more sub-phases, e.g. an increasing acceleration phase, a decreasing acceleration phase, a constant acceleration phase, an increasing deceleration phase, a decreasing deceleration phase, a constant deceleration phase, etc. According to an example, if the elevator hoisting motor 110 is the two-speed DOL induction motor, the elevator drive may comprise two steady state speed phases. In that case the speed data may be obtained during the steady state speed phase of the two steady state speed phases, which has a longer duration. As discussed above, the at least one motion sensor device 550 is configured to obtain the speed data of the elevator hoisting motor 110. The at least one motion sensor device 550 may provide the obtained speed data to the processing unit 510 of the elevator monitoring unit 120. In other words, the processing unit 510 of the elevator monitoring unit 120 may obtain the speed data from the at least one motion sensor device 550.

At a step 220, the processing unit 510 of the elevator monitoring unit 120 defines the load data of the elevator car 102 (m_{load}) based on the obtained speed data, a direction of the elevator drive, and predefined reference data. The defined load data may represent a mass of the load of the elevator car 102. The load data may be expressed as a numerical value, e.g. in kilograms, or as a percentage value, if a nominal load of the elevator car 102 is known. The defined load data of the elevator car 102 includes the mass of the load residing inside the elevator car 102, not the mass of the elevator car 102 itself. The processing unit 510 of the elevator monitoring unit 120 may define the direction of the elevator drive based on the obtained speed data. For example, the direction of the elevator drive may be defined based on the elevator car speed data comprised in the obtained speed data. According to another example, the direction of the elevator drive may be defined based on the rotational speed data comprised in the obtained speed data. The rotational speed data, the elevator car speed data and the slip data vary as function of the load of the elevator car 102 and the direction of the elevator drive, which enables that the load data of the elevator car 102 may be defined based on the obtained speed data and the direction of the elevator drive together with the predefined reference data.

The predefined reference data may comprise a scaling factor and slip data with a known load to the direction of the elevator drive. The predefined reference data may further comprise a synchronous speed data representing a synchronous speed of the elevator motor 110. The synchronous speed data may comprise the synchronous speed of the elevator hoisting motor 110 or speed data of an elevator component representing a correlated value of the synchronous speed of the hoisting motor 110. The elevator component may be any elevator component of the elevator system 110 mechanically linked to the elevator hoisting motor 110 and moved by the elevator hoisting motor 110, e.g. the elevator car 102, a sheave, a pulley, or any other elevator component moved by the elevator hoisting motor 110. For example, if the obtained speed data comprises the elevator car speed data or the rotational speed data, the predefined reference data may further comprise the synchronous speed data for defining the slip data with the known load to the direction of the elevator drive. According to another example, if the obtained speed data comprises the slip data, the synchronous speed data may not be needed to be included in the predefined reference data. The known load may for example be a first known load or a second known load discussed later in this application in connection with a definition of the predefined reference data. The known load means a load, which mass (m_{known}) is known. Alternatively, the known load may be any other known load. The known load may for example be expressed as a numerical value, e.g. in kilograms. The scaling factor represents the relation between the slip data and the load data of the elevator car 102. A value of the scaling factor is the same for both directions of the elevator drive, i.e. upwards and downwards, but the sign of the scaling factor depends on the direction of the elevator drive. In other words, if the scaling factor upwards (kᵤₚ) is positive, the scaling factor downwards (k_{down}) is negative or vice versa (i.e. kᵤₚ=−k_{down}). This is because the slip of the elevator hoisting motor 110 is positive, when driving the elevator car 102 to one direction, and when driving the elevator car 102 to the other direction with the same load of the elevator car 102, the slip of the elevator hoisting motor 110 is negative. However, if the load of the car 102 changes as the direction of the elevator drive changes, then the relationship between the direction of the elevator drive and the slip of the elevator hoisting motor 110 may change. The synchronous speed of the elevator hoisting motor 110 represents a rotational speed of a magnetic field in a stator winding of the elevator hoisting motor 110 caused by the frequency of a generated voltage supplying the elevator motor 110. The synchronous speed of the elevator hoisting motor 110 depends on the frequency of the generated voltage and the number of poles in the elevator hoisting motor 110. The synchronous speed data may for example be expressed in RPM or in m/s. If the elevator hoisting motor 110 is turned at the same RPM as the magnetic field, there would be no relative motion between the rotor and the magnetic field and therefore, no current would be induced into the rotor, and no magnetic field would be created to cause the rotor to turn. The slip of the elevator hoisting motor 110 represents the difference between the synchronous speed of the elevator hoisting motor 110 and the actual speed of the elevator hoisting motor 110.

Next an example for defining the load data of the elevator car 102 based on the obtained speed data, the direction of the elevator drive, and the predefined reference data at the step 220 is discussed. When the direction of the elevator drive is upwards along the elevator shaft 104, the load data of the elevator car 102 (m_{load}) may be defined according to the formula:

$${m}_{load} = ( {S}_{up\_load} - {S}_{up\_known} ) / {k}_{up} + {m}_{known} , \qquad ( 1 )$$

where s_{up_known} is the slip data with the known load upwards, kᵤₚ is the scaling factor upwards, s_{up_load} is slip data with said load data to be defined, i.e. with the load data which is being defined, upwards, and m_{known} is the mass of the known load. The slip data with the load data to be defined upwards may be comprised in the obtained speed data or defined based on the obtained speed data and the synchronous speed data (n_{sync}). As discussed above the obtained speed data may comprise the slip data. In that case the slip data with said load data to be defined upwards (s_{up_load}) is the obtained speed data in the above equation (1). Alternatively, the obtained speed data may comprise the elevator car speed data or the rotational speed data upwards. In that case, the slip data with the load data to be defined upwards may be defined according to the formula:

$${s}_{up\_load} = {n}_{s y n c} - {n}_{up\_load} , \qquad ( 2 )$$

where n_{up_load} is the obtained speed data, when the direction of the elevator drive is upwards.

Alternatively, when the direction of the elevator drive is downwards along the elevator shaft 104, the load data of the elevator car 102 (m_{load}) may be defined according to the formula:

$${m}_{load} = ( {s}_{down\_load} - {s}_{down\_known} ) / {k}_{down} + {m}_{k n o w n} , \qquad ( 3 )$$

where s_{down_known1} is the slip data at the known load downwards, k_{down} is the scaling factor downwards, and s_{down_load} is the slip data with the load data to be defined downwards. The slip data with the load data to be defined downwards may be comprised in the obtained speed data or defined based on the obtained speed data and the synchronous speed data. As discussed above the obtained speed data may comprise the slip data. In that case the slip data with said load data to be defined downwards (s_{down_load}) is the obtained speed data in the above equation (3). Alternatively, the obtained speed data may comprise the elevator car speed data or the rotational speed data downwards. In the latter case, the slip data with the load data to be defined downwards may be defined according to the formula:

$${s}_{down\_load} = {n}_{sync} - {n}_{down\_load} , \qquad ( 4 )$$

where n_{down_load} is the obtained speed data, when the direction of the elevator drive is downwards.

The reference data may be defined during a learning drive of the elevator car 102. The learning drive of the elevator car 102 may be performed for example during an installation phase of the monitoring unit 120. The learning drive may be performed in the elevator system 100 in question, in which the monitoring unit 120 will be implemented. Alternatively, the learning drive may be performed in another elevator system 100 having similar configuration as the elevator system 100, in which the monitoring unit 120 will be implemented. For example, the reference data may be predefined during type tests at a production facility and the monitoring unit 120 with the predefined reference data may be implemented, i.e. installed, to the elevator system 110 without performing the learning drive in said elevator system 100. The predefined reference data may be stored for example to a memory unit 520 of the elevator monitoring unit 120 or the elevator monitoring unit 120 may obtain the predefined reference data from a database.

An example of the learning drive is described by referring to FIG. 3, which illustrates the learning drive as a flow chart. At a step 310, the elevator monitoring unit 120 obtains, by the at least one motion sensor device 550, first reference speed data representing the speed of the elevator hoisting motor 110, when the elevator car 102 with the first known load is driven upwards and downwards along the elevator shaft 104. The first reference speed data may be obtained during the steady state speed phase of the elevator drive, at least partly during the last part of the acceleration phase of the elevator drive, and/or at least partly during the beginning part of the deceleration phase of the elevator drive. Alternatively, the at least one motion sensor device 550 may obtain the first reference speed data continuously during the elevator drive, and the processing unit 510 of the elevator monitoring unit 120 may select from among the continuously obtained first reference speed data the first reference speed data obtained during the steady state speed phase, the first reference speed data obtained at least partly during the last part of the acceleration phase of the elevator drive, and/or the first reference speed data obtained at least partly during the beginning part of the deceleration phase of the elevator drive. The first known load may for example be, but is not limited to, an empty elevator car 102, i.e. a zero load. This is only one example, and any other known load may be used as the first known load. The first reference speed data may comprise the elevator car speed data or the rotational speed data upwards with the first known load (n_{up_known1}) and the elevator car speed data or the rotational speed data downwards with the first known load (n_{down_known1}). Alternatively, the first reference speed data may comprise the slip data upwards with the first known load (s_{up_known1}) and the slip data downwards with the first known load (s_{down_known1}). The first reference speed data upwards and downwards with the first known load may for example be expressed in RPM or in m/s.

At a step 320, the elevator monitoring unit 120 obtains, by the at least one motion sensor device 550, second reference speed data representing the speed of the elevator hoisting motor 110, when the elevator car 102 with the second known load is driven upwards and downwards along the elevator shaft 104. The second reference speed data may be obtained during the steady state speed phase of the elevator drive, at least partly during the last part of the acceleration phase of the elevator drive, and/or at least partly during the beginning part of the deceleration phase of the elevator drive. Alternatively, the at least one motion sensor device 550 may obtain the second reference speed data continuously during the elevator drive, and the processing unit 510 of the elevator monitoring unit 120 may select from among the continuously obtained second reference speed data the second reference speed data obtained during the steady state speed phase, the second reference speed data obtained at least partly during the last part of the acceleration phase of the elevator drive, and/or the second reference speed data obtained at least partly during the beginning part of the deceleration phase of the elevator drive. The second known load is different than the first known load. The second known load may for example be, but is not limited to, a technician, whose mass is known. This is only one example, and any other known load being different than the first known load may be used as the second known load. The second reference speed data may comprise the elevator car speed data or the rotational speed data upwards with the second known load (n_{up_known2}) and the elevator car speed data or the rotational speed data downwards with the second known load (n_{down_known2}). Alternatively, the second reference speed data may comprise the slip data upwards with the second known load (s_{up_known2}) and the slip data downwards with the second known load (s_{down_known2}). The second reference speed data upwards and downwards with the second known load may for example be expressed in RPM or in m/s. In the example of FIG. 3 the step 320 is performed after the step 310, but the step 320 may alternatively be performed before the step 310.

At a step 330, the processing unit 510 of the elevator monitoring unit 120 defines the reference data based on the obtained first reference speed data and the obtained second reference speed data.

FIG. 4 schematically discloses the flow chart of FIG. 3 in more detailed manner. Especially the step 330 becomes clear from FIG. 4. As said the processing unit 510 of the elevator monitoring unit 120 defines the reference data based on the obtained first reference speed data and the obtained second reference speed data at the step 330 during the learning drive. In this example, the first reference speed data comprises the elevator car speed data representing the speed of the elevator car 102 to both directions with the first known load and the second reference speed data comprises the elevator car speed data representing the speed of the elevator car 102 to both directions with the second known load. Alternatively, the first reference speed data may comprise the rotational speed data to both directions with the first known load and the second reference speed data may comprise the rotational speed data to both directions with the second known load as discussed above. In that case the same steps and the same formulas may be used to define the reference data as will be described for the elevator car speed data. Alternatively, the first reference speed data may comprise the slip data with the first known load to both directions and the second reference speed data may comprise the slip data with the second known load to both directions. In that case the steps 410 to 430 may be omitted, and the step 330 comprises only a definition of the scaling factor at a step 440.

At the step 410, the processing unit 510 of the elevator monitoring unit 120 defines the synchronous speed data (n_{sync}) based on the obtained first reference speed data or the obtained second reference speed data. For example, the synchronous speed data may be defined according to the formula:

$${n}_{sync} = ( {n}_{up\_known 1} + {n}_{down\_known 1} ) / 2 , \qquad ( 5 )$$

where n_{up_known1} is the elevator car speed data with the first known load upwards and n_{down_known1} is the elevator car speed data with the first known load downwards. Alternatively, the synchronous speed data may be defined according to the formula:

$${n}_{sync} = ( {n}_{up\_known 2} + {n}_{down\_known 2} ) / 2 , \qquad ( 6 )$$

where n_{up_known2} is the elevator car speed data with the second known load upwards and n_{down_known2} is the elevator car speed data with the second known load downwards.

At the step 420, the processing unit 510 of the elevator monitoring unit 120 defines the slip data with the first known load to both directions (s_{up_known1}, and s_{down_known1}) based on the defined synchronous speed data and the obtained first reference speed data. The slip data with the first known load (s_{up_known1}) upwards may be defined for example according to the formula:

$${s}_{up\_known 1} = {n}_{sync} - {n}_{up\_known 1} . \qquad ( 7 )$$

The slip data with the first known load (s_{down_known1}) downwards may be defined for example according to the formula:

$${s}_{down\_known 1} = {n}_{sync} - {n}_{down\_known 1} . \qquad ( 8 )$$

At the step 430, the processing unit 510 of the elevator monitoring unit 120 defines the slip data with the second known load to both directions (s_{up_known2}, s_{down_known2}) based on the defined synchronous speed data and the obtained second reference speed data. The slip data with the second known load (s_{up_known2}) upwards may be defined for example according to the formula:

$${s}_{up\_known 2} = {n}_{sync} - {n}_{up\_known 2} , \qquad ( 9 )$$

where n_{up_known2} is the elevator car speed data with the second know load upwards. The slip data with the second known load (s_{down_known2}) downwards may be defined for example according to the formula:

$${s}_{down\_known 2} = {n}_{sync} - {n}_{down\_known 2} , \qquad ( 10 )$$

where n_{down_known2} is the elevator car speed data with the second known load downwards. In the example of FIG. 4 the step 430 is performed after the step 420, but the step 430 may alternatively be performed before the step 420.

At the step 440, the processing unit 510 of the elevator monitoring unit 120 defines the scaling factor based on the slip data with the first and second known loads upwards or downwards, and the first and second known loads. As discussed above the data slip may be comprised in the first and second reference speed data or defined in the above-described steps 420 and 430. As also discussed above the value of the scaling factor is the same for both directions of the elevator drive, but the sign of the scaling factor depends on the direction of the elevator drive. Thus, it is sufficient to define the scaling factor either upwards or downwards based on the slip data with the first and second known loads and the first and second known loads, and then define the other one of the scaling factors by changing its sign. The scaling factor may be defined by using the slip data with the known loads upwards for example according to the formula:

$${k}_{u p} = ( {s}_{up\_known 2} - {s}_{up\_known 1} ) / ( {m}_{known 2} - {m}_{known 1} ) , \qquad ( 11 )$$

where s_{up_known2} is the slip data with the second known load upwards, s_{up_known1} is the slip data with the first known load upwards, m_{known1} is the mass of the first known load, and m_{known2} is the mass of the second known load. Alternatively, the scaling factor may be defined by using the slip data with the known loads downwards for example according to the formula:

$${k}_{down} = ( {s}_{down\_known 2} - {s}_{down\_known 1} ) / ( {m}_{known 2} - {m}_{known 1} ) , \qquad ( 12 )$$

where s_{down_known2} is the slip data with the second known load downwards and s_{down_known1} is the slip data with the first known load downwards.

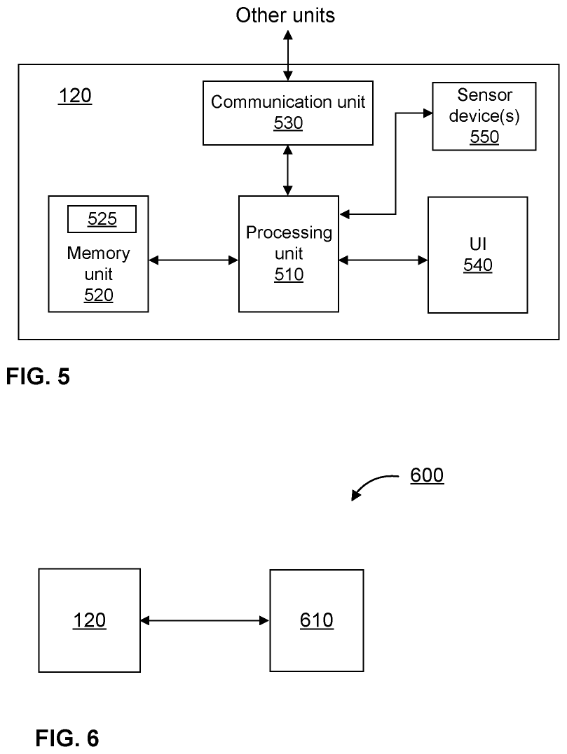

FIG. 5 illustrates schematically an example of components of the elevator monitoring unit 120. The elevator monitoring unit 120 may comprise a processing unit 510 comprising one or more processors, a memory unit 520 comprising one or more memories, the at least one motion sensor device 550 as discussed above, a communication interface unit 530 comprising one or more communication devices, and possibly a user interface (UI) unit 540. The mentioned elements may be communicatively coupled to each other with e.g. an internal bus. The memory unit 520 may store and maintain portions of a computer program (code) 525 and any other data. The computer program 525 may comprise instructions which, when the computer program 525 is executed by the processing unit 510 of the elevator monitoring unit 120 may cause the processing unit 510, and thus the elevator monitoring unit 120 to carry out desired tasks, e.g. one or more of the method steps described above and/or the operations of the elevator monitoring unit 120 described above. The processing unit 510 may thus be arranged to access the memory unit 520 and retrieve and store any information therefrom and thereto. For sake of clarity, the processor herein refers to any unit suitable for processing information and control the operation of the elevator monitoring unit 120, among other tasks. The operations may also be implemented with a microcontroller solution with embedded software. Similarly, the memory unit 520 is not limited to a certain type of memory only, but any memory type suitable for storing the described pieces of information may be applied in the context of the present invention. At least one of the one or more memories of the memory unit 520 may also be comprised by the processing unit 510 as internal memories of the processing unit 510. The communication interface unit 530 provides one or more communication interfaces for communication with any other unit, e.g. with an external computing unit 610, one or more databases, or with any other unit.

The user interface unit 540 may comprise one or more input/output (I/O) devices, such as buttons, keyboard, touch screen, microphone, loudspeaker, display and so on, for receiving user input and outputting information. The elevator monitoring unit 120 may further comprise one or more other sensor devices for obtaining any other data. The computer program 525 may be a computer program product that may be comprised in a tangible nonvolatile (non-transitory) computer-readable medium bearing the computer program code 525 embodied therein for use with a computer, i.e. the elevator monitoring unit 120.

The above-described method and the elevator monitoring unit 120 enable defining the load data of the elevator car 102 without a communicative connection to the elevator system 100 comprising the elevator car 102 by using the at least one motion sensor device 550 being external to the elevator system 100. This improves monitoring capabilities of elevator systems, especially in case of third-party elevator systems. The defined load data of the elevator car 102 may for example be used in a material/people flow estimation. Thus, the method and the elevator monitoring unit 120 discussed above improve the material/people flow estimation. Alternatively or in addition, defined load data of the elevator car 102 may for example be used in a detection of entrapment situations, where a passenger(s) has been entrapped inside the elevator car 102, e.g. when the elevator car 102 stops between landings. Thus, the method and the elevator monitoring unit 120 discussed above improve the detection of the entrapment situations.

According to an embodiment, the elevator monitoring unit 120 may be configured to send the defined load data of the elevator car 102 to an external computing unit 610, e.g. an external server such as a cloud server or any other server external to the elevator system 110. The external computing unit 610 may analyze the load data received from the monitoring unit 120 e.g. for triggering maintenance related tasks. According to another embodiment, the monitoring unit 120 may be configured to send the obtained speed data and the direction of the elevator drive to the external computing unit 610 and the external computing unit may be configured to perform the definition of the load data of the elevator car 102, i.e. the method step 220 described above. Similarly, the monitoring unit 120 may be configured to send the obtained first reference speed data and the second reference speed data to the external computing unit 610 and the external computing unit 610 may be configured to define the reference data, i.e. the method step 330 described above. FIG. 6 illustrates schematically a system 600 comprising the elevator monitoring unit 120 and the external computing unit 610. The external computing unit 610 may be communicatively coupled to the elevator monitoring unit 120. The communication between the elevator monitoring unit 120 and external computing unit 610 may be based on one or more known communication technologies, either wired or wireless.

Above the different examples of the method for defining load data of an elevator car 102 are defined referring to the elevator system 100 comprising one elevator car 102 travelling along one elevator shaft 104. However, the elevator system 100 may also comprise an elevator group, i.e. group of two or more elevator cars 102 each travelling along a respective elevator shaft 104 configured to operate as a unit serving the same landings 106a-106n. All the above discussed examples also apply to the elevator system 100 comprising the elevator group. For example, the elevator system 100 comprising the elevator group may comprise for each elevator car 102 of the elevator group a respective elevator monitoring unit 102 configured to define load data of said elevator car 102.

The specific examples provided in the description given above should not be construed as limiting the applicability and/or the interpretation of the appended claims. Lists and groups of examples provided in the description given above are not exhaustive unless otherwise explicitly stated.

1. A method for defining load data of an elevator car, the method comprises:
obtaining, by at least one motion sensor device, speed data representing a speed of an asynchronous elevator hoisting motor arranged to drive the elevator car along an elevator shaft, and
defining the load data of the elevator car based on the obtained speed data, a direction of the elevator drive, and predefined reference data.

2. The method according to claim 1, wherein the predefined reference data comprises a scaling factor and slip data with a known load to the direction of the elevator drive.

3. The method according to claim 2, wherein the predefined reference data further comprises a synchronous speed data.

4. The method according to claim 1, wherein when the direction of the elevator drive is upwards the load data of the elevator car is defined according to the formula:
$${m}_{load} = ( {s}_{up\_load} - {s}_{up\_known} ) / {k}_{up} + {m}_{known} ,$$
where s_{up_known} is slip data with the known load upwards, kᵤₚ is a scaling factor upwards, s_{up_load} is slip data with the load data to be defined upwards, and m_{known} is a mass of the known load, wherein the slip data with the load data to be defined upwards is comprised in the obtained speed data or defined based on the obtained speed data and synchronous speed data, or
wherein when the direction of the elevator drive is downwards the load data of the elevator car is defined according to the formula:
$${m}_{load} = ( {s}_{down\_load} - {s}_{down\_known} ) / {k}_{down} + {m}_{known} ,$$
where s_{down_known} is slip data with the known load downwards, k_{down} is a scaling factor downwards, and s_{down_load} is slip data with the load data to be defined downwards, wherein the slip data with the load data to be defined downwards is comprised in the obtained speed data or defined based on the obtained speed data and the synchronous speed data.

5. The method according to claim 1, wherein the reference data is defined during a learning drive of the elevator car.

6. The method according to claim 5, wherein the learning drive comprises:
obtaining first reference speed data representing the speed of the elevator hoisting motor of the elevator hoisting motor, when the elevator car with a first known load is driven upwards and downwards along the elevator shaft,
obtaining second reference speed data representing the speed of the elevator hoisting motor of the elevator hoisting motor, when the elevator car with a second known load is driven upwards and downwards along the elevator shaft, and
defining the reference data based on the obtained first reference speed data and the obtained second reference speed data.

7. The method according to claim 6, wherein the defining the reference data during the learning drive comprises:
defining synchronous speed databased on the obtained first reference speed data or the obtained second reference speed data,
defining slip data with the first known load to both directions based on the defined synchronous speed and the obtained first reference speed data,
defining slip data with the second known load to both directions based on the defined synchronous speed and the obtained second reference speed data, and
defining the scaling factor based on the defined slip data with the known loads upwards or downwards, and the known first and second loads.

8. The method according to claim 6, wherein the defining the reference data during the learning drive comprises defining the scaling factor based on slip data with the known loads upwards or downwards, and the known first and second loads, wherein the slip data with the first known load upwards and downwards is comprised in the obtained first reference speed data and the slip data with the second known load upwards and downwards is comprised the second reference speed data.

9. The method according to claim 1, wherein the at least one motion sensor device is comprised by an elevator monitoring unit without a communicative connection to an elevator control system of an elevator system comprising the elevator car.

10. The method according to claim 1, wherein the asynchronous elevator hoisting motor is a direct-on-line (DOL) induction motor or a frequency-controlled induction motor.

11. An elevator monitoring unit for defining load data of an elevator car, the monitoring unit comprises:
at least one motion sensor device configured to obtain speed data representing a speed of an asynchronous elevator hoisting motor arranged to drive the elevator car along an elevator shaft, and
a processing unit configured to:
obtain the speed data from the at least one motion sensor device, and
define the load data of the elevator car based on the obtained speed data, a direction of the elevator drive, and predefined reference data.

12. The elevator monitoring unit according to claim 11, wherein the predefined reference data comprises a scaling factor and slip data with a known load to the direction of the elevator drive.

13. The elevator monitoring unit according to claim 12, wherein the predefined reference data further comprises a synchronous speed data.

14. The elevator monitoring unit according to claim 11, wherein when the direction of the elevator drive is upwards, the processing unit is configured to define the load data of the elevator car according to the formula:
$${m}_{load} = ( {s}_{up\_load} - {s}_{up\_known} ) / {k}_{up} + {m}_{known} ,$$
where s_{up_known} is slip data with a known load upwards, kᵤₚ is a scaling factor upwards, s_{up_load} is a slip data with the load data to be defined upwards, and m_{known} is a mass of the known load, wherein the slip data with the load data to be defined upwards is comprised in the obtained speed data or defined based on the obtained speed data and a synchronous speed data, or wherein when the direction of the elevator drive is downwards, the processing unit is configured to define the load data of the elevator car according to the formula:
$${m}_{load} = ( {s}_{down\_load} - {s}_{down\_known} ) / {k}_{down} + {m}_{known} ,$$
where s_{down_known} is slip data with the known load downwards, k_{down} is a scaling factor downwards, and s_{down_load} is slip data with the load data to be defined downwards, wherein the slip data with the load data to be defined downwards is comprised in the obtained speed data or defined based on the obtained speed data and the synchronous speed data.

15. The elevator monitoring unit according to claim 11, wherein the processing unit is configured to define the reference data during a learning drive of the elevator car.

16. The elevator monitoring unit according to claim 15, wherein the learning drive comprises that the processing unit is configured to:
obtain first reference speed data representing the speed of the elevator hoisting motor, when the elevator car with a first known load is driven upwards and downwards along the elevator shaft,
obtain second reference speed data representing the speed of the elevator hoisting motor, when the elevator car with a second known load is driven upwards and downwards along the elevator shaft, and
define the reference data based on the obtained first reference speed data and the obtained second reference speed data.

17. The elevator monitoring unit according to claim 16, wherein the defining the reference data during the learning drive comprises that the processing unit is configured to:
define synchronous speed data based on the obtained first reference speed data or the obtained second reference speed data,
define slip data with the first known load to both directions based on the defined synchronous speed and the obtained first reference speed data,
define slip data with the second known load to both directions based on the defined synchronous speed and the obtained second reference speed data, and
define the scaling factor based on the defined slip data of the elevator hoisting motor with the known loads upwards or downwards and the known first and second loads.

18. The elevator monitoring unit according to claim 16, wherein the defining the reference data during the learning drive comprises that the processing unit is configured to define the scaling factor based on slip data of the elevator hoisting motor with the known loads upwards or downwards and the known first and second loads, wherein the slip data with the first known load upwards and downwards is comprised in the obtained first reference speed data and the slip data with the second known load upwards and downwards is comprised the second reference speed data.

19. The elevator monitoring unit according to claim 11, wherein the elevator monitoring unit is without a communicative connection to an elevator control system of an elevator system comprising the elevator car.

20. The elevator monitoring unit according to claim 11, wherein the asynchronous elevator hoisting motor is a direct-on-line (DOL) induction motor or a frequency-controlled induction motor.

21. A computer program product for defining load data of an elevator car which, when executed by a computer, cause the computer to perform the method according to claim 1.

22. A system comprising:
the elevator monitoring unit according to claim 11, and an external computing unit configured to:
receive the load data of the elevator car from the elevator monitoring unit, and
store and analyze the received load data of the elevator car.
